(19) United States
(12) Patent Application Publication
(10) Pub. No.: US 2017/0264989 A1
(43) Pub. Date: Sep. 14, 2017

(54) ACOUSTIC ADJUSTING SYSTEM, EARPHONE DEVICE AND ACOUSTIC ADJUSTING METHOD THEREOF

(71) Applicant: Jetvox Acoustic Corp., Taoyuan City (TW)

(72) Inventor: To-Teng HUANG, Taoyuan (TW)

(21) Appl. No.: 15/156,688

(22) Filed: May 17, 2016

(30) Foreign Application Priority Data
Mar. 11, 2016 (TW) 105107686

(51) Int. Cl. H04R 1/10

(52) U.S. Cl. CPC H04R 1/1041

(57) ABSTRACT

An acoustic adjusting system includes an audio device and an earphone device. The audio device includes an acoustic adjusting module, an audio player, and a first communicating unit. The acoustic adjusting module generates an acoustic setting data; the audio player generates an audio signal; and the first communicating unit receives the acoustic setting data and the audio signal, and then outputs the acoustic setting data and the audio signal. The earphone device includes a second communicating unit, an erasable acoustic data memory, a digital signal processor, and an electroacoustic transducer. The acoustic setting data is stored in the erasable acoustic data memory by erasable means. The digital signal processor processes digitally the audio signal into a processed audio signal according to the acoustic setting data stored in the erasable acoustic data memory. The electroacoustic transducer converts the processed audio signal then plays it.

### CROSS-REFERENCES TO RELATED APPLICATIONS

This non-provisional application claims priority under 35 U.S.C. §119(a) on Patent Application No. 105107686 filed in Taiwan, R.O.C. on 2016 Mar. 11, the entire contents of which are hereby incorporated by reference.

### BACKGROUND

Technical Field

The present invention is related to an acoustic earphone, especially to an acoustic adjusting system, an earphone device applied to the acoustic adjusting system, and the acoustic adjusting method for the system.

Related Art

As Internet transmission speed has increased dramatically and wireless signal may cover wider and wider, handheld-devices such as smart phones and PAD devices have become very common in everyday life. Smart phones or PAD devices can installed varies applications for such as games, music players, video players, cameras, and telecommunications, so as to combine many functions of the digital products. The music player is important for the smart phones or the PAD devices because, for example, music or sound effects are played with or by the video player, games, or advertisements of the websites, etc. In addition, there are many applications for different music players, such as Spotify, SoundCloud, KKbox, YOUZEEK, MuziTube, and QianQianJingTing (now called Baidu Music) etc., in different countries.

In general, when user(s) use a smart phone, a PAD device, or other audio devices to listen to music, to play games, or to watch videos, he/she would use an earphone in order not to disturb other people. User may have different favorite music, such as a symphony, a jazz, a rock and roll, an electronic music, etc. The user may further have different favorite sound fields, such as a Dolby 5.1 channel, a music hall, a theater stage, a concert environment, or a basement environment, etc. Normally, the applications for playing music may provide with an equalizer interface for the user to adjust the gain of the specific frequency band. However, the applications installed in the smart phone or the PAD devices are custom for different user, which are unique for each user with independently operation. However, the feature of independently operation needs the user to adjust the gain of the specific frequency band for each application because the adjustment in one application cannot be used in another application, which may be inconvenient for the user. For example, the adjustment for “Youtube”, set by the equalizer interface, cannot be used for “Spotify”. When the user wants to use “Spotify”, it is required to adjust again for the gain of the specific frequency band of “Spotify”.

Traditionally, the earphone in the market for sale is already set by the manufacture. Moreover, according to different customer's need, the frequency bands or the sound fields may be set as, for example, heavy bass, monitoring, analog theater, analog music hall, or surround music, etc. However, when the user wants to use a specific earphone in different environment, it may be limited to the default set by the manufacture though the equalizer interface is already provided to adjust the frequency bands or the sound fields, and the sound may not reach the desired effects. For example, when an earphone specialized for heavy bass is used to monitor a stage, it may not resolve the frequency band and the sound is unclear because of the set of the bass. Thus, the customer may need to use different earphones when in different environments, and it is not easy to adjust and costs high for customers.

### SUMMARY

In order to solve the problems of incompatible for different frequency bands or sound fields in different applications in smartphones, PAD devices, or other audio devices, one or more embodiments of the present invention is provided. Thus the customers may have more economic choice and customized function for listening to the music. The embodiments of the instant disclosure provide an acoustic adjusting system, an earphone applied to the system, and an acoustic adjusting method to achieve the aforementioned objectives.

The instant disclosure provides an audio device, and an earphone device. The audio device may be a smartphone, a PAD device, a laptop computer, a PC, a MP3 player, etc. The audio device may comprise a graphic user interface for the user to adjust the acoustic setting. The audio device comprises an acoustic adjusting module, an audio player, and a first communicating unit. The acoustic adjusting module generates acoustic setting data, and the acoustic setting data comprises at least one of frequency band setting data and sound field setting data. The audio player generates an audio signal. The first communicating unit is connected electronically to the acoustic adjusting module and the audio player for receiving and outputting the acoustic setting data and the audio signal.

The earphone device may refer to an earphone part itself; alternatively the earphone device may comprise an earphone part and peripheral parts. The earphone device comprising a second communicating unit, an erasable acoustic data memory, a digital signal processor, and an electroacoustic transducer. The second communicating unit is connected electronically to the erasable acoustic data memory and the digital signal processor. The second communicating unit is communicated with the first communicating unit for receiving the acoustic setting data and the audio signal. The acoustic setting data is stored in the erasable acoustic data memory by erasable means. The digital signal processor is connected electronically to the erasable acoustic data memory. The digital signal processor receives the audio signal by way of the second communicating unit and processes digitally the audio signal into a processed audio signal according to the acoustic setting data in the erasable acoustic data memory. The digital signal processor outputs the processed audio signal, and the electroacoustic transducer receives and converts the processed audio signal by electroacoustic means for playing.

In one embodiment, the earphone device comprises an amplifier device and an earphone part. The amplifier device comprises the second communicating unit, the erasable acoustic data memory, the digital signal processor, and an output terminal. The output terminal is connected electronically to the digital signal processor for receiving and outputting the processed audio signal. The earphone part comprises the electroacoustic transducer and an input terminal connected electronically to the electroacoustic transducer, and the input terminal is communicated with the output terminal for receiving the processed audio signal and transmitting the processed audio signal to the electroacoustic transducer.

In one embodiment, the audio device comprises a database connected electronically to the acoustic adjusting module, and the acoustic setting data generated by the acoustic adjusting module is stored in the database.

In one embodiment, the audio device further comprises a cloud database, wherein the cloud database is communicated with the first communicating unit, and the acoustic setting data generated by the acoustic adjusting module is stored in the cloud database by way of the first communicating unit. Accordingly, when the user changes for another audio device, the cloud database may be used for restoring the previous setting of the acoustic setting data.

In one embodiment, the audio device further comprises a database connected electronically to the acoustic adjusting module, wherein the database is stored with acoustic presetting data. Each acoustic presetting data is a frequency band presetting data or a sound field presetting data. The acoustic adjusting module selects at least one acoustic presetting data from the database, and the acoustic setting data comprises the selected acoustic presetting data. The erasable acoustic data memory stores with the selected acoustic setting data. Additionally, the acoustic adjusting system further comprises a cloud database storing with updated acoustic data, wherein the cloud database is communicated with the first communicating unit. The audio device downloads the updated acoustic data and stores into the database for updating the acoustic presetting data.

In one embodiment, the acoustic adjusting system further comprises a cloud database storing with acoustic presetting data. The cloud database is communicated with the first communicating unit. Each acoustic presetting data is a frequency band presetting data or a sound field presetting data. The acoustic adjusting module selects at least one acoustic presetting data from the cloud database, wherein the acoustic setting data comprises the selected acoustic presetting data. The erasable acoustic data memory stores the selected acoustic setting data.

In another aspect of the instant disclosure, an earphone device is provided and is adapted to the acoustic adjusting system. The earphone device comprises a communicating unit, an erasable acoustic data memory, a digital signal processor, and an electroacoustic transducer. The communicating unit receives acoustic setting data and an audio signal from an outer source, wherein the acoustic setting data comprises at least one frequency band setting data and sound field setting data. The erasable acoustic data memory is connected electronically to the communicating unit for storing the acoustic setting data by an erasable means. The digital signal processor is connected electronically to the erasable acoustic data memory and the communicating unit. The digital signal processor receives the audio signal by way of the communicating unit. According to the acoustic setting data in the erasable acoustic data memory, the digital signal processor processes digitally the audio signal into a processed audio signal for outputting. The electroacoustic transducer receives and converts electroacoustically the processed audio signal for playing.

The earphone device may refer to an earphone part itself; alternatively the earphone device may comprise an earphone part and peripheral parts. In one embodiment, the earphone device comprises an amplifier device and an earphone part. The amplifier device comprising the communicating unit, the erasable acoustic data memory, the digital signal processor, and an output terminal. The output terminal is connected electronically to the digital signal processor for receiving and outputting the processed audio signal. The earphone part comprises the electroacoustic transducer and an input terminal connected electronically to the electroacoustic transducer. The input terminal is communicated with the output terminal for receiving the processed audio signal and transmitting the processed audio signal to the electroacoustic transducer.

In another embodiment, the earphone device may comprise an earphone part, a control box, and a control line while the earphone device is in a smaller type such as an earbud or a behind-the-head headset. The earphone part comprises the electroacoustic transducer. The control box comprises the communicating unit, the erasable acoustic data memory, and the digital signal processor. The control line is connected to and between the earphone part and the control box. Accordingly, the digital signal processor of the control box and the electroacoustic transducer of the earphone part are connected electronically by the control line.

In one embodiment, the erasable acoustic data memory is an Electrically-Erasable Programmable Read-Only Memory (EEPROM), which is used for example not limitation. For example the erasable acoustic data memory may be an Erasable Programmable Read Only Memory (EPROM), a Ferroelectric Random Access Memory, etc.

In one embodiment, the communicating unit is a wireless communicating unit. The communicating unit may be a receiver of wireless signal via wireless communication such as wifi, Bluetooth, or ZigBee, etc for receiving the acoustic setting data and the audio signal. In one embodiment, the communicating unit may be a wired communication port such as an USB port, a Micro USB port, or a lightning port, etc, applied with a higher voltage to write or erase the acoustic setting data into the erasable acoustic data memory.

In one embodiment, the erasable acoustic data memory and the digital signal processor are integrated into an acoustic process chip by using an IC process so as to downsize the whole device.

In a further aspect of the present invention, an acoustic adjusting method is provided. The method comprises: actuating an acoustic adjusting module of an audio device, wherein the audio device comprises a first communicating unit connected electronically to the acoustic adjusting module; adjusting the acoustic adjusting module for generating acoustic setting data, wherein the acoustic setting data comprises at least one of frequency band setting data and sound field setting data; transmitting the acoustic setting data to a second communicating unit of an earphone device from the first communicating unit, wherein the earphone device comprises an erasable acoustic data memory connected electronically to the second communicating unit; and storing the acoustic setting data into the erasable acoustic data memory.

In one embodiment, the earphone device further comprises an electroacoustic transducer and a digital signal processor connected electronically to the second communicating unit and the erasable acoustic data memory for receiving an audio signal and, and the method comprising: processing the audio signal into a processed audio signal according to the acoustic setting data in the erasable acoustic data memory; and receiving and converting electroacoustically the processed audio signal for playing in the electroacoustic transducer.

In one embodiment, the earphone device comprises an amplifier device and an earphone part. The amplifier device comprises the second communicating unit, the erasable acoustic data memory, the digital signal processor, and an output terminal. The output terminal is connected electronically to the digital signal processor for receiving and outputting the processed audio signal. The earphone part comprises the electroacoustic transducer and an input terminal connected electronically to the electroacoustic transducer. The input terminal is communicated with the output terminal. The electroacoustic transducer receives the processed audio signal via the communication between the input terminal and the output terminal in the step of receiving the processed audio signal.

In one embodiment, the step of adjusting the acoustic adjusting module for generating acoustic setting data further comprises a step of storing the acoustic setting data into a database connected electronically to the acoustic adjusting module.

In one embodiment, the step of adjusting the acoustic adjusting module for generating acoustic setting data further comprises a step of storing the acoustic setting data into a cloud database by way of the first communicating unit communicated with the cloud database.

In one embodiment, the acoustic setting data generated by the acoustic adjusting module is selected from a database connected electronically to the acoustic adjusting module, and the database is stored with acoustic presetting data. In addition, before the step of adjusting the acoustic adjusting module for generating acoustic setting data further comprising: downloading updated acoustic data from a cloud database by the first communicating unit communicated with the cloud database; and storing the downloaded updated acoustic data into the database for updating the acoustic setting data. The cloud database is communicated with the first communicating unit.

In one embodiment, the acoustic setting data generated by the acoustic adjusting module is selected from a cloud database communicated with the first communicating unit, and the cloud database is stored with acoustic presetting data.

In one embodiment, the audio device comprises an audio player connected electronically to the first communicating unit for generating the audio signal, and the first communicating unit transmits the audio signal to the second communicating unit in the step of transmitting the acoustic setting data to the second communicating unit.

In summary, after the acoustic setting data is adjusted in the audio device, the acoustic setting data can be stored in the erasable acoustic data memory by the erasable means. Consequently, when the audio signal from the outer source is transmitted to the earphone device, the digital signal processor may process digitally the audio signal according to the acoustic setting data in the erasable acoustic data memory. The setting problem for different players independently and repeatedly can be overcome. Meanwhile, because the earphone device may provide the customer customized satisfaction, the customer may use the earphone device in different environments. The user (or the customer) may adjust sound as he/she desire when in different field or environment, and a more economic choice is provided for the customer.

### BRIEF DESCRIPTION OF THE DRAWINGS

FIG. 1 is a schematic diagram showing the first embodiment for an acoustic adjusting system of the instant disclosure;

FIG. 2 is a perspective view showing the first embodiment for an earphone used in an acoustic adjusting system of the instant disclosure;

FIG. 3 is a perspective view showing the second embodiment for an earphone used in an acoustic adjusting system of the instant disclosure;

FIG. 4 is a process flowchart showing the first embodiment for an acoustic adjusting method of the instant disclosure;

FIG. 5 is a perspective view showing the third embodiment for an earphone used in an acoustic adjusting system of the instant disclosure;

FIG. 6 is a schematic diagram showing the second embodiment for an acoustic adjusting system of the instant disclosure; and

FIG. 7 is a process flowchart showing the second embodiment for an acoustic adjusting method of the instant disclosure.

### DETAILED DESCRIPTION

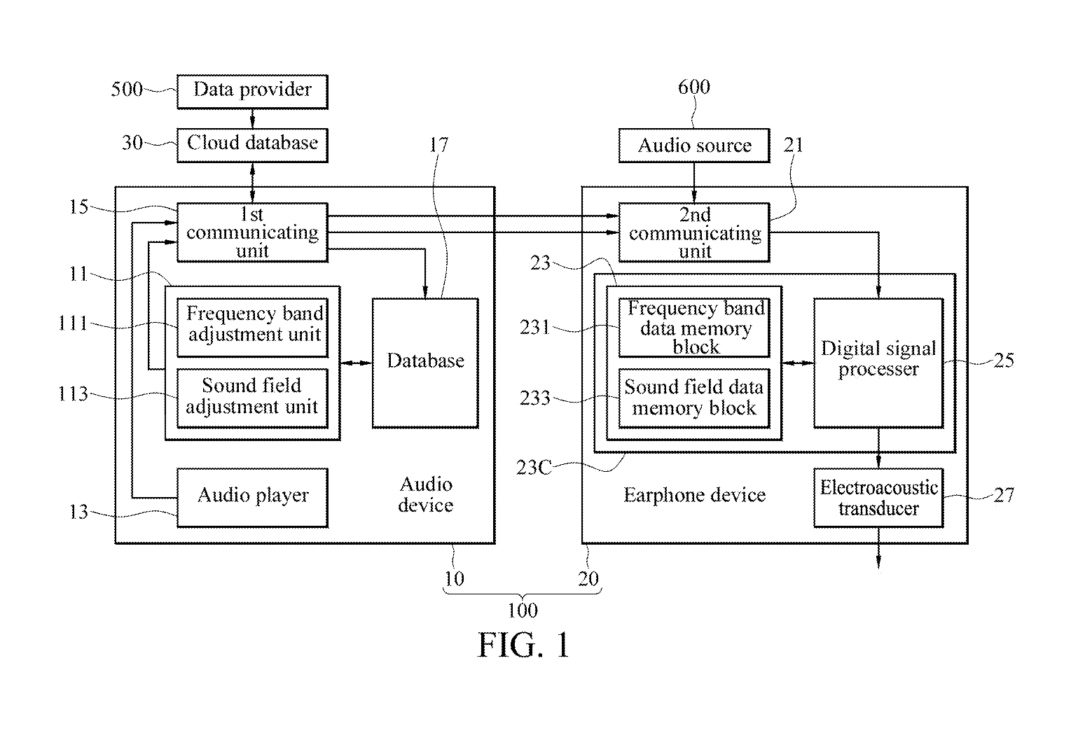

Please refer to FIG. 1, which is a schematic diagram showing the first embodiment for an acoustic adjusting system of the instant disclosure. In the first embodiment, the acoustic adjusting system 100 comprises an audio device 10 and an earphone device 20. The audio device 10 comprises an acoustic adjusting module 11, an audio player 13, and a first communicating unit 15.

In one embodiment, the audio device 10 may be a smartphone, a PAD device, a laptop computer, a PC, a MP3 players, etc. The audio device 10 may comprise a graphic user interface for the user to adjust the acoustic setting. The acoustic adjusting module 11 may be an interface or an application for generating acoustic setting data. In further details, the acoustic adjusting module 11 may comprises a frequency band adjustment unit 111 and a sound field adjustment unit 113 for generating frequency band setting data and sound field setting data, respectively. The frequency band setting data may comprise setting values for a gain, a frequency vector, and/or a bandwidth (also called “Q factor”). The sound field setting data may comprise setting values for simulation effects such as a Dolby 5.1 channel, a music hall, a lecture hall, a theater stage, a concert environment, or a basement environment, etc. The acoustic setting data comprises at least one of the frequency band setting data and the sound field setting data. In other words, the acoustic setting data may comprise only the frequency band setting data, only the sound field setting data, or both the frequency band setting data and the sound field setting data. The audio player 13 generates an audio signal. The first communicating unit 15 is connected electronically to the acoustic adjusting module 11 and the audio player 13 for receiving and outputting the acoustic setting data and the audio signal.

The earphone device 20 comprises a second communicating unit 21, an erasable acoustic data memory 23, a digital signal processor 25, and an electroacoustic transducer 27. The second communicating unit 21 is connected electronically to the erasable acoustic data memory 23 and the digital signal processor 27. The second communicating unit 21 is communicated with the first communicating unit 15 for receiving the acoustic setting data and the audio signal, wherein the acoustic setting data is stored in the erasable acoustic data memory 23 by erasable means. In other words, the erasable acoustic data memory 23 is stored with the acoustic setting data. The digital signal processor 25 is connected electronically to the erasable acoustic data memory 23. The digital signal processor 25 receives the audio signal by way of the second communicating unit 21. According to the acoustic setting data stored in the erasable acoustic data memory 23, the digital signal processor 25 processes digitally the audio signal to a processed audio signal for outputting. In one embodiment, the digital signal processor 25 may re-process with such as sampling or filtering the amplitude and/or the frequency of the audio signal, so as to form the processed audio signal. The electroacoustic transducer 27 is connected electronically to the digital signal processor 25 for receiving and converting electroacoustically the processed audio signal for playing.

In one embodiment, the second communicating unit 21 may be a wired communication port such as an USB port, a Micro USB port, or a lightning port, etc. When the communication unit 21 is wired to connect with the first communicating unit 15, a higher voltage can be applied. Thus, the acoustic setting data can be wrote into the erasable acoustic data memory 23 by directly using a voltage to write and erase. Alternatively, the second communicating unit 21 may be a wireless unit, such as a wireless communication receiver of wifi, Bluetooth, or ZigBee, etc. When the second communicating unit 21 is a wireless unit, the first communicating unit 15 can be acted as a wireless transmitter matching with the second communicating unit 21 for communication therebetween. The acoustic setting data can be wrote into the erasable acoustic data memory 23 by a voltage scaling conversion. Alternatively, the acoustic setting data can be sent to the digital signal processor 25 for writing into the erasable acoustic data memory 23.

In addition, the erasable acoustic data memory 23 may be an electrically-erasable programmable read-only memory (EEPROM), which is an example for description not for limitation. Other practical examples, include, not limited to, erasable programmable read only memory (EPROM0, ferroelectric random access memory (FRAM), etc. In more details, the erasable acoustic data memory 23 further comprises a frequency band data memory block 231 and a sound field data memory block 233 for storing the frequency band setting data and the sound field setting data, respectively.

Please again refer to FIG. 1. The audio device 10 further comprises a database 17 electronically connecting to the acoustic adjusting module 11. The acoustic setting data generated by the acoustic adjusting module 11 may be stored into the database 17. Furthermore, the acoustic adjusting system 100 may comprise a cloud database 30 communicated with the first communicating unit 15. The acoustic setting data generated by the acoustic adjusting module 11 may be stored into the database 17 by way of the first communicating unit 15. Accordingly, the acoustic setting data may be stored into at least one of the database 17 and the cloud database 30. The acoustic setting data may be an acoustic presetting data for later use. The cloud database 30 may further provide a function for a user to recover the acoustic setting data after changing the audio device 10.

In another embodiment, the database 17 of the audio device 10 is stored with acoustic presetting data. Each acoustic presetting data is a frequency band presetting data or a sound field presetting data. For example, the frequency band presetting data comprises classical music, jazz music, rock music, electronic music, pop music, etc. The sound field presetting data comprises a Dolby 5.1 channel, a 7.1 channel, a surround channel, a music hall, a lecture hall, a theater stage, an outdoors environment, etc. The acoustic adjusting module 11 selects at least one acoustic presetting data from the database 17. The acoustic setting data comprises the selected acoustic presetting data. And the selected acoustic presetting data transmitted by the first communicating unit 15 and the second communicating unit 21 can be stored in the erasable acoustic data memory 23 by erasable means.

In another embodiment, the cloud database 30 is stored with acoustic presetting data. The acoustic adjusting module 11 selects at least one acoustic presetting data from the cloud database 30 by way of the first communicating unit 15. The acoustic setting data comprises the selected acoustic presetting data. Similarly, acoustic adjusting module 11 transmits the selected acoustic presetting data by way of the first communicating unit 15 and the second communicating unit 21 to the erasable acoustic data memory 23 for storing erasablly. In this embodiment, all acoustic presetting data may be stored within the cloud database 30, so the database 17 of the audio device 10 can be omitted to save the storage space.

In summary, the acoustic setting data can be adjusted directly and generated by the acoustic adjusting module 11; alternatively, the acoustic setting data can be selected from the acoustic presetting data stored in the database 17 or the cloud database 30. Furthermore, the acoustic setting data may be generated by a previous stored acoustic setting data (i.e., adjustment setting value).

Moreover, the cloud database 30 stores with updated acoustic data provided from a data provider 500. The data provider 500 can be an original manufacture or a specific person such as a DJ or a sound engineer who needs to adjust sound. The audio device 10 may download the updated acoustic data from the cloud database 30 and store in the database 17 for updating the acoustic presetting data. The words, “update, updated, or updating”, not only means replacing the old version with the new version, but also means adding new acoustic presetting data. When the updated acoustic data is provided by the specific person, the user may buy the updated acoustic data from a payment platform formed with the cloud database 30.

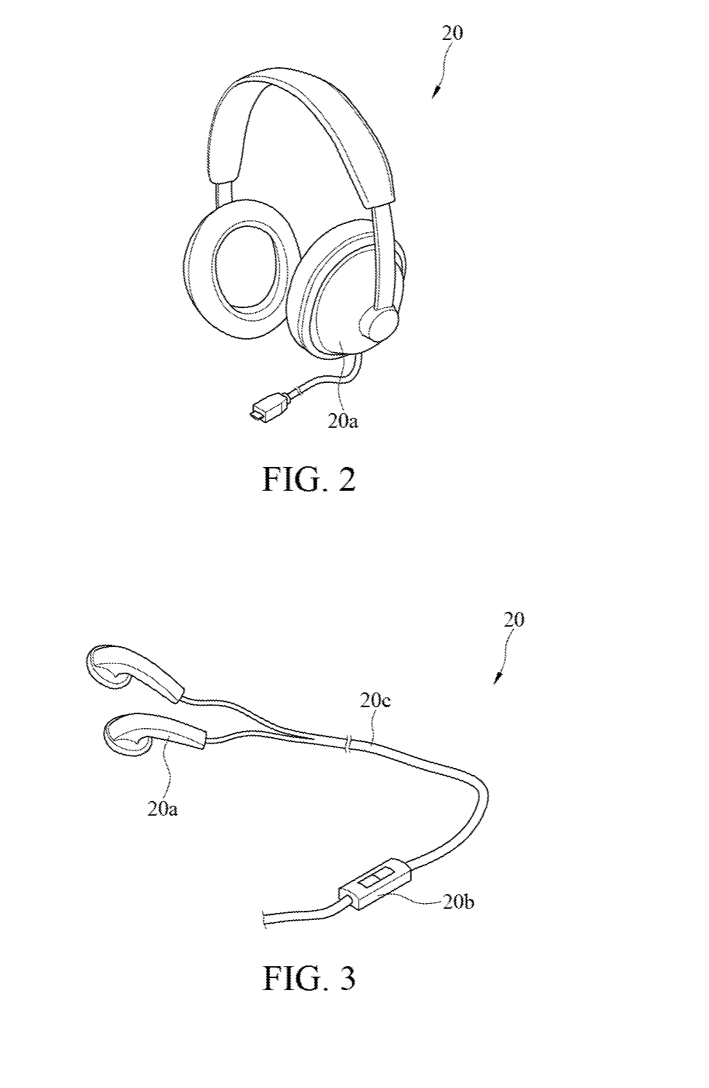

Please refer to FIG. 2 and FIG. 3, which shows the first embodiment and the second embodiment for earphones used in an acoustic adjusting system of the instant disclosure, respectively. The instant disclosure provides an earphone device 20, as shown in FIG. 2, which is a full size headset comprising an earphone part 20a. The earphone part 20a comprises a communicating unit (the second communicating unit 21), an erasable acoustic data memory 23, a digital signal processor 25, and an electroacoustic transducer 27 (as shown in right side of FIG. 1).

As shown in FIG. 3, the earphone device 20 comprises an earphone part 20a, a control box 20b, and a control line 20c. The earphone device 20 in FIG. 3 is an earbud comprising an earphone part 20a. The earphone device 20 shown in figures are used to describe the examples, which are not used to limit the present invention. For example, the earphone device 20 shown in FIG. 3 may be a behind-the-head headset or a full size headset. In the embodiment of FIG. 3, the earphone part 20a comprises an electroacoustic transducer 27, and the control box 20b comprises a communicating unit (i.e. the second communicating unit 21), the erasable acoustic data memory 23, and the digital signal processor 25 (as shown in right side of FIG. 1). The control line 20c connected electronically between the earphone part 20a and the control box 20b. In this embodiment, the electroacoustic transducer 27 is connected electronically to the digital signal processor 25 by way of the control line 20c.

When the earphone device 20 is already set with the acoustic setting data, the acoustic status can be saved as previous setting. Even though the earphone device 20 is disconnected with the audio device 10, when the earphone device 20 is communicated with an outer audio source 600 such as an MP3 player or other audio device, the acoustic status as previous setting can be used. In addition, referring back to FIG. 1, when considering the size or the function, the above embodiments can be applied with an IC process to integrate the erasable acoustic data memory 23 and the digital signal processor 25 into an acoustic process chip 23c.

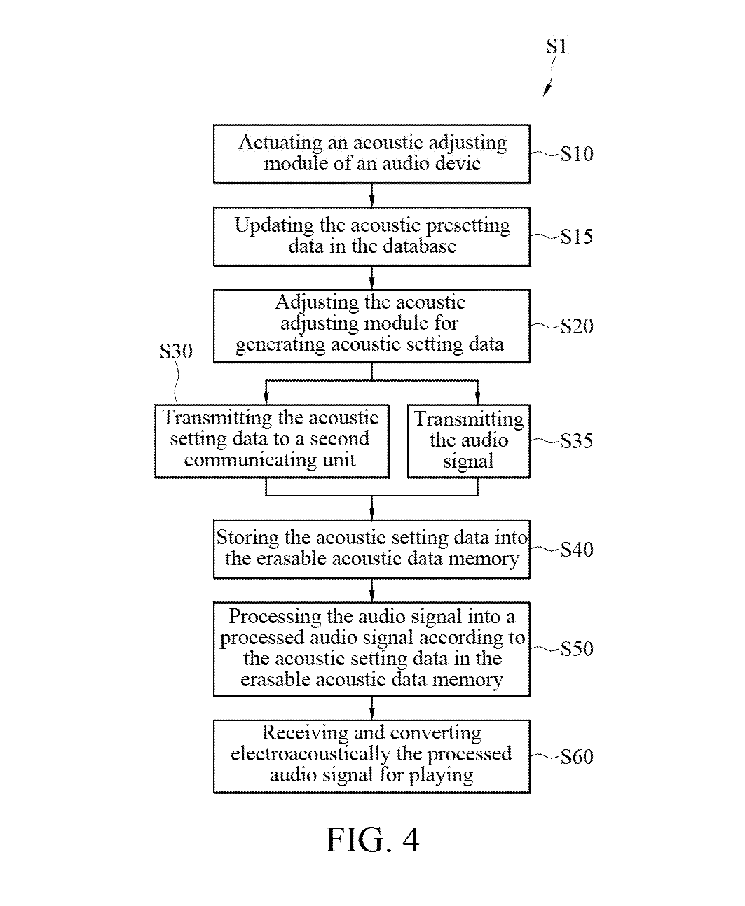

Please refer to FIG. 4, which is a flowchart showing the first embodiment for an acoustic adjusting method of the instant disclosure. Refer to FIG. 4 accompanying with the block diagram in FIG. 1, the acoustic adjusting method S1 of the first embodiment comprises Steps S10 to S40. Step S10 is to actuate an acoustic adjusting module 11 in an audio device 10. Step S20 is to adjust the setting of the acoustic adjusting module 11 for generating acoustic setting data, wherein the acoustic setting data comprises at least one of frequency band setting data and sound field setting data. In Step S30, a first communicating unit 15 transmits the acoustic setting data to a second communicating unit 21 of an earphone device 20. The acoustic setting data is stored in an erasable acoustic data memory 23 by erasable means, as shown in Step S40. In the Step S40, the acoustic setting data may use a voltage, a voltage scaling conversion, or a digital signal processor 25 to write into or erase from the erasable acoustic data memory 23 for different embodiments.

When the second communicating unit 21 of the earphone device 20 receives an audio signal from, for example, the audio device 10 or from the outer audio source 600 when the audio device 10 is disconnected. The acoustic adjusting method S1 of the first embodiment further comprises Steps S50 and S60. In Step S50, the digital signal processor 25 processes digitally the audio signal into a processed audio signal according to the acoustic setting data stored in the erasable acoustic data memory 23. In Step S60, the electroacoustic transducer 27 converts electroacoustically the processed audio signal for playing. When the audio signal is generated by the audio player 13 of the audio device 10, Step S30 may further comprises Step S35: the first communicating unit 15 further transmitting the audio signal to the second communicating unit 21 at the same time. That is, the acoustic setting data and the audio signal may be sent at the same time or not (i.e., by turns).

Moreover, after Step S20, the acoustic setting data is stored in a database 17 or is stored in a cloud database 30 by way of the first communicating unit 15. In other words, after the acoustic adjusting module 20 adjusts the settings, the acoustic setting data can be stored in at least one of the database 17 and the cloud database 30.

In addition, the acoustic adjusting module 11 may select acoustic presetting data stored in the database 17 in Step S20, wherein the acoustic setting data comprises the selected acoustic presetting data. Alternatively, the acoustic adjusting module 11 may select acoustic presetting data stored in the cloud database 30, wherein the acoustic setting data comprises the selected acoustic presetting data. In other words, the acoustic setting data may be adjusted directly and generated by the acoustic adjusting module 11; alternatively, the acoustic setting data may be selected from the acoustic presetting data stored in the database 17 or the cloud database 30. Each acoustic presetting data may be a frequency band presetting data or a sound field presetting data.

Furthermore, please refer back to FIG. 4. Before the acoustic adjusting method S1 processes digitally the Step S20, the method further comprises a new Step S15: the first communicating unit 15 downloading updated acoustic data from the cloud database 30 and storing in the database 17 for updating the acoustic presetting data in the database 17.

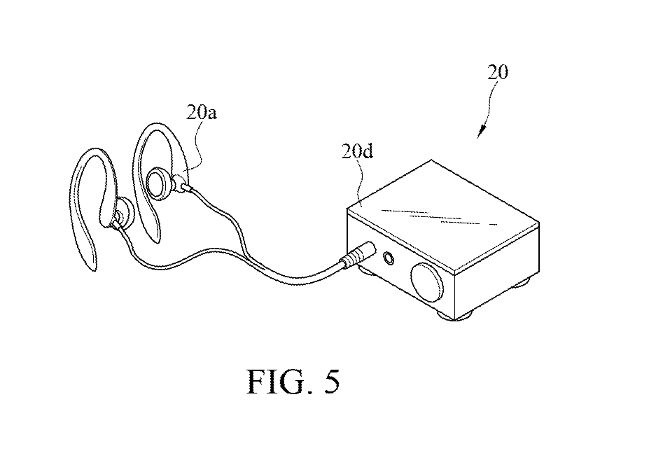

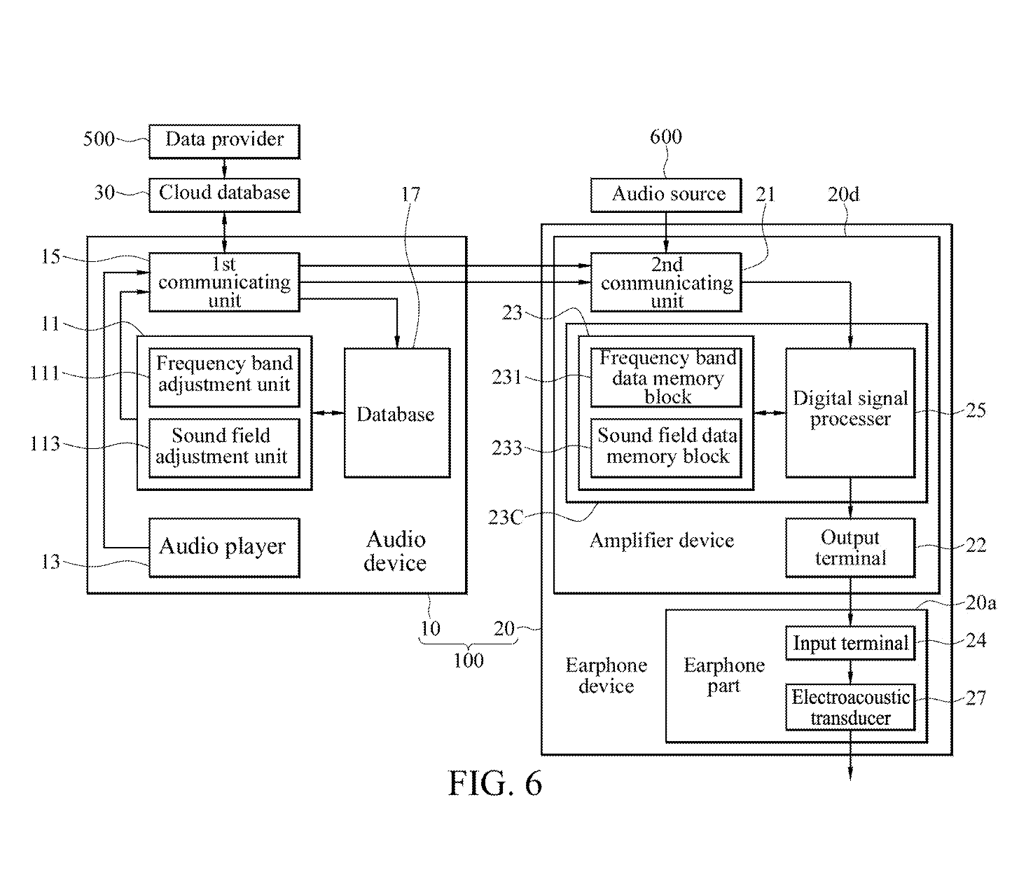

Please refer to FIG. 5 and FIG. 6. FIG. 5 is a perspective view showing the third embodiment for an earphone used in an acoustic adjusting system of the instant disclosure, and FIG. 6 is a schematic diagram showing the second embodiment for an acoustic adjusting system of the instant disclosure. The earphone device in the third embodiment is applied to the acoustic adjusting system in the second embodiment, which is different from FIG. 1 to FIG. 3. As shown in FIG. 5, the earphone device 20 of the third embodiment comprises an earphone part 20a and an amplifier device 20d. The earphone device 20 in FIG. 5 is a behind-the-head headset, however, which is not used to limit the present invention. The earphone device 20 may also be an earbud or a full-size headset. The amplifier device 20d is wired to connect to the earphone part 20a, which is not used to limit the present invention. The amplifier device 20d may be communicated with the earphone part 20a wirelessly by way of wifi, Bluetooth, or ZigBee, etc.

As shown in FIG. 6, the acoustic adjusting system 100 of the second embodiment comprises an audio device 10 and an earphone device 20, wherein the audio device 10 is similar to the first embodiment. Below will describe in more details about the earphone device 20. The earphone device 20 comprises an earphone part 20a and an amplifier device 20d. The amplifier device 20d comprises a second communicating unit 21, an erasable acoustic data memory 23, a digital signal processor 25, and an output terminal 22. The second communicating unit 21 is connected electronically to the erasable acoustic data memory 23 and the digital signal processor 27. The second communicating unit 21 is communicated with the first communicating unit 15 for receiving the acoustic setting data and the audio signal. The acoustic setting data can be stored in the erasable acoustic data memory 23 by erasable means. The digital signal processor 25 receives the audio signal by way of the second communicating unit 21 and processes digitally the audio signal into a processed audio signal in accordance with the acoustic setting data stored in the erasable acoustic data memory 23. The output terminal 22 is connected electronically to the digital signal processor 25 for receiving and outputting the processed audio signal.

The earphone part 20a comprises an input terminal 24 and an electroacoustic transducer 27. The input terminal 24 is connected electronically to the electroacoustic transducer 27 and communicated with the output terminal 22 for receiving and transmitting the processed audio signal to the electroacoustic transducer 27. The electroacoustic transducer 27 receives and converts electroacoustically the processed audio signal for playing.

According to the earphone device 20 in the second embodiment, the second communicating unit 21 of the amplifier device 20d may be a wired communication port such as an USB port, a Micro USB port, or a lightning port, etc. When the communication unit 21 is wired to connect with the first communicating unit 15, a higher voltage can be applied. Thus, the acoustic setting data can be wrote into the erasable acoustic data memory 23 by directly using a voltage to write and erase. Alternatively, the second communicating unit 21 may be a wireless unit, such as a wireless communication receiver of wife, Bluetooth, or ZigBee, etc. When the second communicating unit 21 is a wireless unit, the first communicating unit 15 can be acted as a wireless transmitter matching with the second communicating unit 21 for communication therebetween.

The acoustic setting data can be wrote into the erasable acoustic data memory 23 by a voltage scaling conversion. Alternatively, the acoustic setting data can be sent to the digital signal processor 25 for writing into the erasable acoustic data memory 23. Furthermore, the output terminal 22 and the input terminal 24 may be pairing wired communicating units or wireless communicating units.

In order to consider the size or the function, the erasable acoustic data memory 23 and the digital signal processor 25 may be integrated into an acoustic process chip 23c, wherein the acoustic process chip 23c and other components of the amplifier device 20d may be placed on the same PCB.

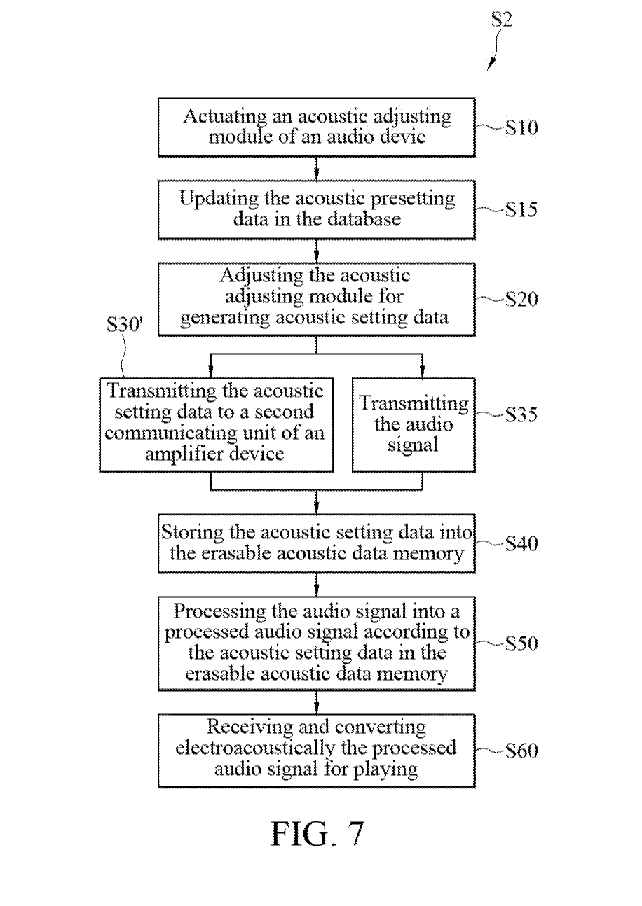

Please refer to FIG. 7, which is a process flowchart showing the second embodiment for an acoustic adjusting method of the instant disclosure. Accompanying with FIG. 6, the acoustic adjusting method S2 of the second embodiment as shown in FIG. 7 comprises Steps S10, S20, S30′ and S40. Step S10 is to actuate an acoustic adjusting module 11 of an audio device 10. Step S20 is to adjust the setting of the acoustic adjusting module 11 for generating acoustic setting data, wherein the acoustic setting data comprises at least one of frequency band setting data and sound field setting data. The difference between this embodiment and the first embodiment is in Step S30′: the communicating unit 15 transmitting the acoustic setting data to a second communicating unit 21 of an amplifier device 20d. The acoustic setting data is stored in an erasable acoustic data memory 23 by erasable means, as shown in Step S40. In Step S40, the acoustic setting data may use a voltage, a voltage scaling conversion, or a digital signal processor 25 to write into or erase from the erasable acoustic data memory 23 for different embodiments.

When the second communicating unit 21 of the amplifier device 20d receives an audio signal from, the acoustic adjusting method S2 of the second embodiment further comprises Steps S50 and S60. In Step S50, the digital signal processor 25 processes digitally the audio signal into a processed audio signal according to the acoustic setting data stored in the erasable acoustic data memory 23. In Step S60, the electroacoustic transducer 27 converts electroacoustically the processed audio signal for playing. In Step S40 of the second embodiment, the electroacoustic transducer 27 receives the processed audio signal from the amplifier device 22d by way of the input terminal 24 connected with the output terminal 22. In the second embodiment, the audio signal may comes from the audio device 10 or the outer audio source 600.

Similar to the first embodiment, Step S30 in the second embodiment may further comprise Step S35: the first communicating unit 15 further transmitting the audio signal to the second communicating unit 21 at the same time. That is, the acoustic setting data and the audio signal may be sent at the same time or not (i.e., by turns).

The difference between the first and the second embodiments is that the later comprises the second communicating unit 21, the erasable acoustic data memory 23, and the digital signal processor 25 being disposed on the amplifier device 20d, and the amplifier device 20d is apart from the earphone part 20a physically. Accordingly, the acoustic setting data is transmitted first to the amplifier device 20d, and the processed audio signal is then transmitted to the earphone part 20a from the amplifier device 20d. For other detail description, please refer to the first embodiment and FIG. 4.

It can be understood that the audio device may store the generated or selected acoustic setting data into the erasable acoustic data memory of the earphone device by erasable means. Thus, when the audio signal from an outer source is transmitted to the earphone device, the digital signal processor may process the audio signal according to the acoustic setting data stored in the erasable acoustic data memory, so as to overcome the setting problem as describing in the background by using the hardware. Though varies applications for playing music or sound in such as smart phones, PAD devices, or other audio device are unique for each user with independently operation, the instant disclosure don't need to adjust manually the gain of the specific frequency band for each application. Because the earphone device may provide the customer customized satisfaction, the customer may use the earphone device in different environments. The user (customer) may adjust sound as he/she desire, so a more economic choice is provided for the customer.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An acoustic adjusting system comprising:
an audio device comprising an acoustic adjusting module, an audio player, and a first communicating unit, wherein the acoustic adjusting module generates acoustic setting data comprising at least one of frequency band setting data and sound field setting data, the audio player generates an audio signal, and the first communicating unit is connected electronically to the acoustic adjusting module and the audio player for receiving and outputting the acoustic setting data and the audio signal; and
an earphone device comprising a second communicating unit, an erasable acoustic data memory, a digital signal processor, and an electroacoustic transducer, wherein the second communicating unit is connected electronically to the erasable acoustic data memory and the digital signal processor, wherein the second communicating unit is communicated with the first communicating unit for receiving the acoustic setting data and the audio signal, wherein the acoustic setting data is stored in the erasable acoustic data memory by erasable means, wherein the digital signal processor connected electronically to the erasable acoustic data memory receives the audio signal by way of the second communicating unit and processes digitally the audio signal into a processed audio signal according to the acoustic setting data in the erasable acoustic data memory, and the electroacoustic transducer receives and converts electroacoustically the processed audio signal for playing.

2. The acoustic adjusting system according to claim 1, wherein the earphone device comprises an amplifier device and an earphone part, the amplifier device comprising the second communicating unit, the erasable acoustic data memory, the digital signal processor, and an output terminal connected electronically to the digital signal processor for receiving and outputting the processed audio signal, wherein the earphone part comprises the electroacoustic transducer and an input terminal connected electronically to the electroacoustic transducer, and the input terminal is communicated with the output terminal for receiving the processed audio signal and transmitting the processed audio signal to the electroacoustic transducer.

3. The acoustic adjusting system according to claim 1, wherein the audio device further comprises a database connected electronically to the acoustic adjusting module, and the acoustic setting data generated by the acoustic adjusting module is stored in the database.

4. The acoustic adjusting system according to claim 2, wherein the audio device further comprises a database connected electronically to the acoustic adjusting module, and the acoustic setting data generated by the acoustic adjusting module is stored in the database.

5. The acoustic adjusting system according to claim 1, further comprising a cloud database, wherein the cloud database is communicated with the first communicating unit, and the acoustic setting data generated by the acoustic adjusting module is stored in the cloud database by way of the first communicating unit.

6. The acoustic adjusting system according to claim 2, further comprising a cloud database, wherein the cloud database is communicated with the first communicating unit, and the acoustic setting data generated by the acoustic adjusting module is stored in the cloud database by way of the first communicating unit.

7. The acoustic adjusting system according to claim 1, wherein the audio device further comprises a database connected electronically to the acoustic adjusting module, wherein the database is stored with acoustic presetting data, wherein each acoustic presetting data is a frequency band presetting data or a sound field presetting data, wherein the acoustic adjusting module selects at least one acoustic presetting data from the database, wherein the acoustic setting data comprises the selected acoustic presetting data, and the erasable acoustic data memory stores with the selected acoustic setting data.

8. The acoustic adjusting system according to claim 2, wherein the audio device further comprises a database connected electronically to the acoustic adjusting module, wherein the database is stored with acoustic presetting data, wherein each acoustic presetting data is a frequency band presetting data or a sound field presetting data, wherein the acoustic adjusting module selects at least one acoustic presetting data from the database, wherein the acoustic setting data comprises the selected acoustic presetting data, and the erasable acoustic data memory stores with the selected acoustic setting data.

9. The acoustic adjusting system according to claim 7, further comprising a cloud database storing with updated acoustic data, wherein the cloud database is communicated with the first communicating unit, and the audio device downloads the updated acoustic data and stores into the database for updating the acoustic presetting data.

10. The acoustic adjusting system according to claim 8, further comprising a cloud database storing with updated acoustic data, wherein the cloud database is communicated with the first communicating unit, and the audio device downloads the updated acoustic data and stores into the database for updating the acoustic presetting data.

11. The acoustic adjusting system according to claim 1, further comprising a cloud database storing with acoustic presetting data, wherein the cloud database is communicated with the first communicating unit, wherein each acoustic presetting data is a frequency band presetting data or a sound field presetting data, wherein the acoustic adjusting module selects at least one acoustic presetting data from the cloud database, wherein the acoustic setting data comprises the selected acoustic presetting data, and the erasable acoustic data memory stores with the selected acoustic setting data.

12. The acoustic adjusting system according to claim 2, further comprising a cloud database storing with acoustic presetting data, wherein the cloud database is communicated with the first communicating unit, wherein each acoustic presetting data is a frequency band presetting data or a sound field presetting data, wherein the acoustic adjusting module selects at least one acoustic presetting data from the cloud database, wherein the acoustic setting data comprises the selected acoustic presetting data, and the erasable acoustic data memory stores with the selected acoustic setting data.

13. An earphone device comprising:
a communicating unit for receiving an audio signal and acoustic setting data from an outer source, wherein the acoustic setting data comprises at least one frequency band setting data and sound field setting data;
an erasable acoustic data memory connected electronically to the communicating unit for storing erasablly the acoustic setting data;
a digital signal processor connected electronically to the erasable acoustic data memory and the communicating unit, wherein the digital signal processor receives the audio signal by way of the communicating unit and processes digitally the audio signal into a processed audio signal for outputting according to the acoustic setting data in the erasable acoustic data memory; and
an electroacoustic transducer receiving and converting electroacoustically the processed audio signal for playing.

14. The earphone device according to claim 13, further comprising an amplifier device and an earphone part, wherein:
the amplifier device comprises the communicating unit, the erasable acoustic data memory, the digital signal processor, and an output terminal connected electronically to the digital signal processor for receiving and outputting the processed audio signal; and
the earphone part comprises the electroacoustic transducer and an input terminal connected electronically to the electroacoustic transducer, and the input terminal is communicated with the output terminal for receiving and transmitting the processed audio signal to the electroacoustic transducer.

15. The earphone device according to claim 13, wherein the earphone device comprises:
an earphone part comprising the electroacoustic transducer;
a control box comprising the communicating unit, the erasable acoustic data memory, and the digital signal processor; and
a control line connected to and between the earphone part and the control box.

16. An acoustic adjusting method comprising:
actuating an acoustic adjusting module of an audio device, wherein the audio device comprises a first communicating unit connected electronically to the acoustic adjusting module;
adjusting the acoustic adjusting module for generating acoustic setting data, wherein the acoustic setting data comprises at least one of frequency band setting data and sound field setting data;
transmitting the acoustic setting data to a second communicating unit of an earphone device from the first communicating unit, wherein the earphone device comprises an erasable acoustic data memory connected electronically to the second communicating unit; and
storing the acoustic setting data into the erasable acoustic data memory.

17. The acoustic adjusting method according to claim 16, wherein the earphone device further comprises an electroacoustic transducer and a digital signal processor connected electronically to the second communicating unit and the erasable acoustic data memory for receiving an audio signal and, and the method comprising:
processing the audio signal into a processed audio signal according to the acoustic setting data in the erasable acoustic data memory; and
receiving and converting electroacoustically the processed audio signal for playing in the electroacoustic transducer.

18. The acoustic adjusting method according to claim 17, wherein the earphone device comprises:
an amplifier device comprising the second communicating unit, the erasable acoustic data memory, the digital signal processor, and an output terminal connected electronically to the digital signal processor; and
an earphone part comprising the electroacoustic transducer and an input terminal connected electronically to the electroacoustic transducer, and the input terminal is communicated with the output terminal; and
wherein the electroacoustic transducer receives the processed audio signal via the communication between the input terminal and the output terminal in the step of receiving the processed audio signal.

19. The acoustic adjusting method according to claim 16, wherein the step of adjusting the acoustic adjusting module for generating acoustic setting data further comprises:
storing the acoustic setting data into a database connected electronically to the acoustic adjusting module.

20. The acoustic adjusting method according to claim 16, wherein the step of adjusting the acoustic adjusting module for generating acoustic setting data further comprises:
storing the acoustic setting data into a cloud database by way of the first communicating unit communicated with the cloud database.

21. The acoustic adjusting method according to claim 16, wherein the acoustic setting data generated by the acoustic adjusting module is selected from a database connected electronically to the acoustic adjusting module, and the database is stored with acoustic presetting data.

22. The acoustic adjusting method according to claim 21, before the step of adjusting the acoustic adjusting module for generating acoustic setting data further comprising:
downloading updated acoustic data from a cloud database by the first communicating unit communicated with the cloud database; and
storing the downloaded updated acoustic data into the database for updating the acoustic setting data.

23. The acoustic adjusting method according to claim 16, wherein the acoustic setting data generated by the acoustic adjusting module is selected from a cloud database communicated with the first communicating unit, and the cloud database is stored with acoustic presetting data.

24. The acoustic adjusting method according to claim 17, wherein the audio device comprises an audio player connected electronically to the first communicating unit for generating the audio signal, and the first communicating unit transmits the audio signal to the second communicating unit in the step of transmitting the acoustic setting data to the second communicating unit.
